(19) United States
(12) Patent Application Publication
(10) Pub. No.: US 2012/0187048 A1
(43) Pub. Date: Jul. 26, 2012

(54) SYSTEMS AND METHODS FOR SCOURING MEMBRANE BIOREACTORS

(75) Inventors: Ted Jenkins, Charleston, SC (US); Boyd Gregg, Daniel Island, SC (US)

(73) Assignee: Enviro-Mix, LLC, Charleston, SC (US)

(21) Appl. No.: 13/358,384

(22) Filed: Jan. 25, 2012

Related U.S. Application Data
(60) Provisional application No. 61/436,130, filed on Jan. 25, 2011.

(51) Int. Cl. B01D 65/02

(52) U.S. Cl. 210/741; 210/409; 210/143; 210/106; 210/96.2; 210/739

(57) ABSTRACT

A system and method for scouring membranes in a membrane bioreactor system are disclosed. The system employs scouring devices and controls by which pressurized air creates bursts of bubbles that act to scour the membranes of fouling.

### BACKGROUND

The present application claims priority to U.S. Provisional Patent Application Ser. No. 61/436,130, filed on Jan. 25, 2011 and incorporated herein by reference in its entirety.

In operation, hardware components may require cleaning in order to allow the components to continue operation at an efficient level. This is especially true for systems in a wastewater environment, such as a membrane bioreactor used for wastewater treatment. The present invention provides a novel system and method for cleaning membrane bioreactor systems and other membranes where scouring is required.

### SUMMARY OF THE INVENTION

The present invention includes a scouring system for use in scouring membranes in a membrane bioreactor. The scouring system employs a source of pressurized gas connected to a supply line, a nozzle connected to the supply line, wherein the nozzle has a nipple connected to at least one partially enclosed channel with at least two outlets, the at least two outlets being located at opposite distal ends of the channel and each of the outlets defining a passage through which short bursts of pressurized gas from the source of pressurized gas may be released simultaneously to form a burst of a plurality of bubbles from each outlet. A valve is located between the source of compressed air and the nozzle and the nozzle is located in proximity to a membrane of a membrane bioreactor such that a burst of bubbles released from the nozzle scours the membrane.

The present invention further a system for automatically controlling a maintenance scouring process for membranes in a membrane bioreactor based upon at least one dynamically-measured parameter. The system includes a probe for dynamically measuring at least one parameter within the system and a computer, which is in communication with the probe and receives data from the probe representing the measurement of the at least one dynamically-measured parameter. The system also includes a controller in communication with the computer, and a scouring device in communication with the controller. The system activates the scouring device based upon measurement of a first parameter characteristic of the dynamically-measured parameter and the system deactivates the scouring device based upon measurement of a second parameter characteristic of a dynamically-measured parameter. In addition, the scouring device is located in proximity to a membrane of a membrane bioreactor such that a burst of bubbles released from the scouring device scours the membrane.

The present invention also includes a method for controlling the scouring of a membrane in a membrane bioreactor based upon dynamically-measured data. The method includes measuring at least one parameter of the membrane bioreactor system, activating scouring of the membrane based upon measurement of a first characteristic of the measured parameter, and deactivating scouring of the membrane based upon measurement of a second characteristic of a measured parameter. The scouring of the method is accomplished by emitting from a scouring device a burst of a plurality of bubbles in proximity to the membrane such that the burst of bubbles released from the scouring device scours the membrane.

The present invention may be better understood by reference to the description and figures that follow. It is to be understood that the invention is not limited in its application to the specific details as set forth in the following description and figures. The invention is capable of other embodiments and of being practiced or carried out in various ways.

### BRIEF DESCRIPTION OF THE DRAWINGS

These and other features, aspects, and advantages of the present invention are better understood when the following detailed description is read with reference to the accompanying drawings, wherein:

FIG. 1 is a schematic view of an embodiment of a membrane bioreactor system having a scouring system;

FIG. 2A is a front, cut-away view of an embodiment of a nozzle of the present invention in which the spacers (shown if FIG. 2B) are omitted for clarity;

FIG. 2B is an end view of the nozzle shown in FIG. 2A;

FIG. 2C is a top view of the nozzle depicted in FIG. 2A;

FIG. 3 is a drawing showing the flow of gas into and out of the nozzle depicted in FIG. 2A;

FIG. 4 is a side vim of the nozzle shown in FIG. 3 showing rising scouring bubbles;

FIG. 5 is a drawing that provides a representation of pathways that may be created by embodiments of nozzles used in the present invention; and

FIG. 6 is a schematic illustrating the scouring of membranes in a membrane bioreactor in accordance with one embodiment of the present invention.

Repeat use of reference characters in the present specification and drawings is intended to represent same or analogous features or elements of the invention.

### DETAILED DESCRIPTION OF EXEMPLARY EMBODIMENTS

Reference will now be made in detail to various embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents. In addition, U.S. patent application Ser. No. 12/577,529 and U.S. Patent Application Ser. No. 61/389,645 are incorporated herein in their entireties by reference thereto.

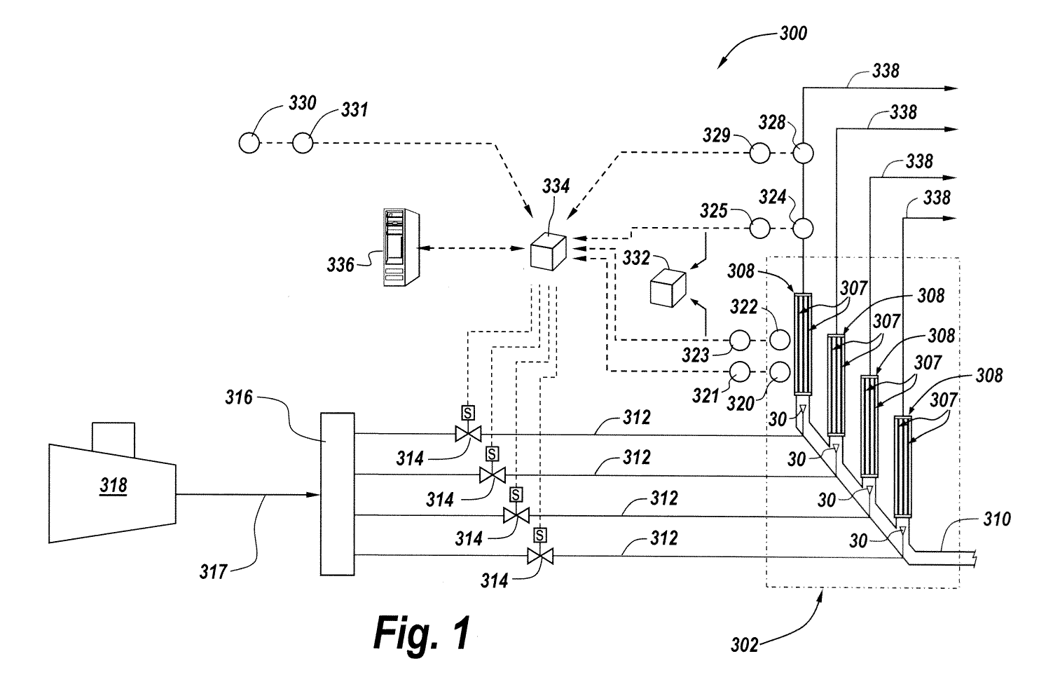

FIG. 1 provides a schematic representation of an embodiment of a scouring device in conjunction with a membrane bioreactor system that may be utilized in wastewater treatment. The device is shown as a “Smartcycle” device, but that is in name only and is not meant to be limiting in any manner. In the depicted embodiment, system 300 includes a basin 302, shown only schematically. It will be appreciated that an exemplary embodiment of a containment unit that can be used with the present invention may include four sidewalls and a bottom, and may be constructed of concrete. One of ordinary skill in the art will appreciate that alternative types of containment units, such as tanks, vessels, channels, and ditches, are also within the scope of the present invention. As shown in FIG. 1, inlet pipe 310 may be connected to four membrane bioreactor units in basin 302, which are shown as cassettes 308. Outlet pipes 338 for carrying away of treated wastewater are connected at the other ends of cassettes 308. In some embodiments, inlet pipes 310 and/or outlet pipes 338 may not be directly connected to cassettes 308. In some embodiments, multiple containment units, of the same type or of differing types, may be utilized and connected.

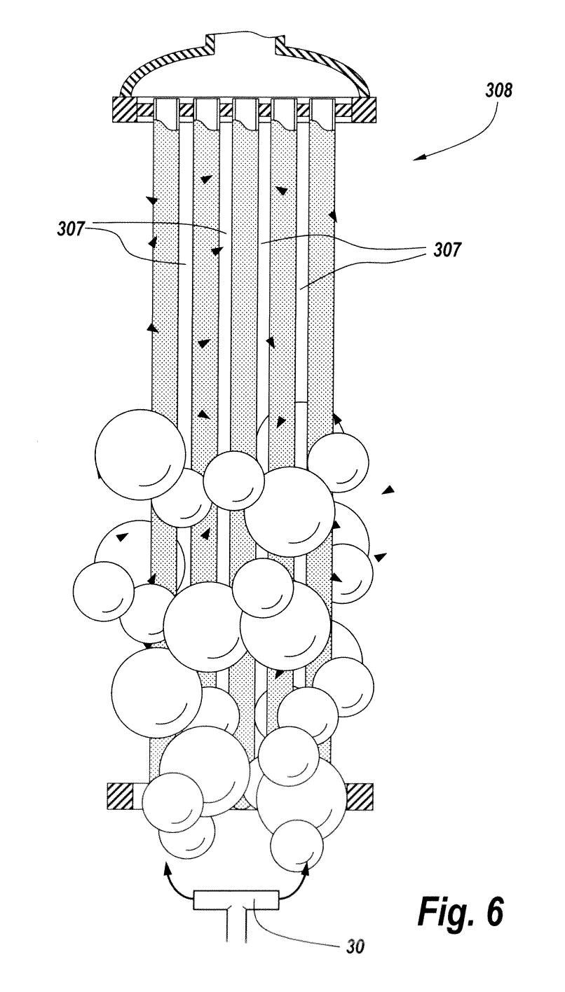

As shown in FIG. 6, cassettes 308 may include internal membranes 307. One of ordinary skill in the art will appreciate that alternative types and embodiments of membrane bioreactor units are within the scope of the present invention. Similarly, the number and arrangement of cassettes 308 can vary within different embodiments of the present invention. Furthermore, in other embodiments of the invention, membranes 307 can be arranged within a basin and some embodiments may also include membranes house in enclosed cassettes, such as cassettes having cassette walls. In other embodiments, membranes 307 may be secured in a basin for aerobic treatment or another type of treatment process. The present invention may be used for a variety of membranes, including, without limitation, flat-plate membrane systems.

System 300 also includes scouring device nozzles 30 located at an end of cassette 308, as described subsequently herein. One of ordinary skill in the art will appreciate that alternative quantities and/or arrangements of nozzles are within the scope of the present invention. By way of example, and without limitation, a nozzle may be located between the ends of two cassettes, wherein the openings of the nozzle are positioned such that bubbles rise through each cassette, as described herein.

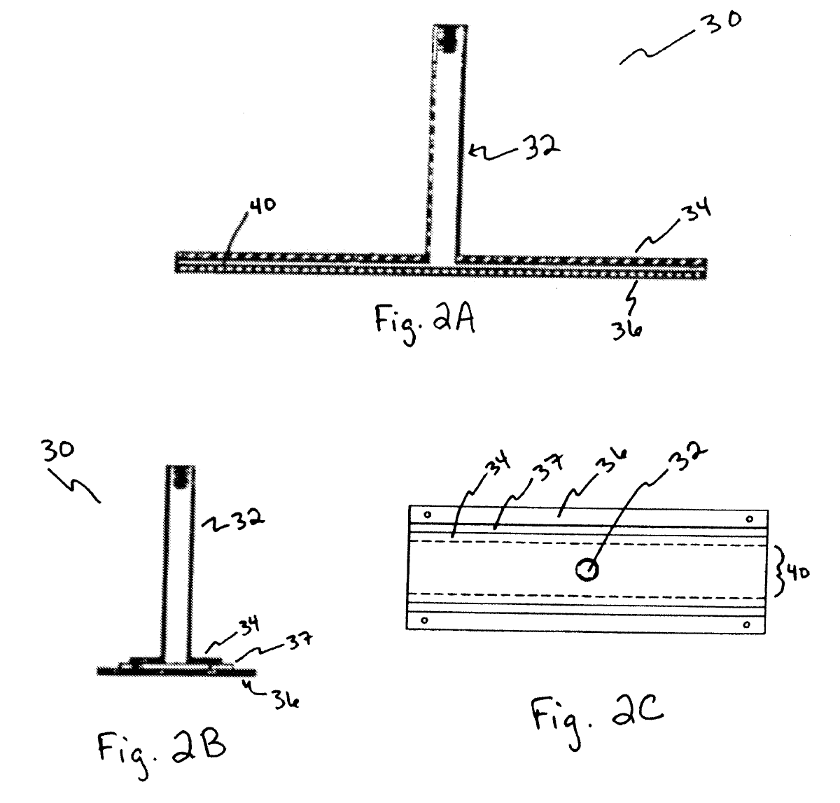

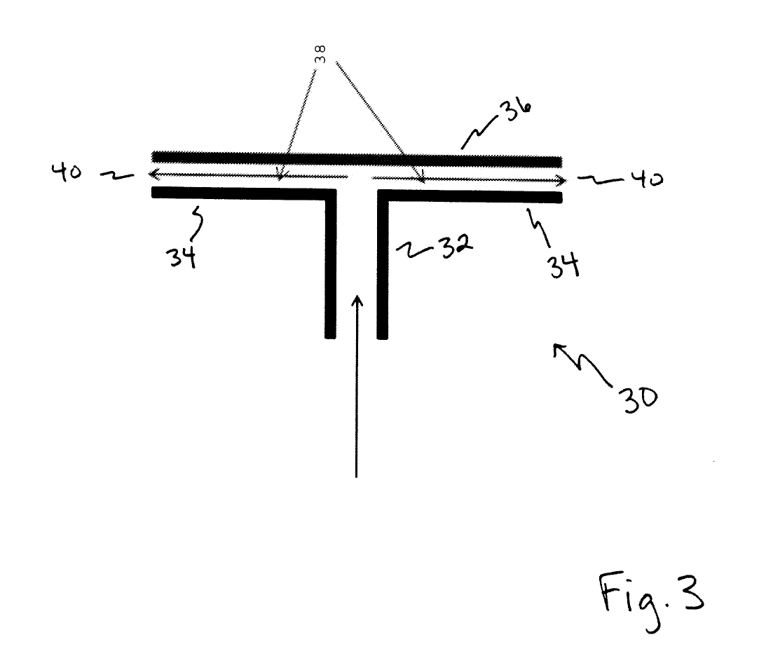

Although one of ordinary skill in the art will appreciate that various types of nozzles can be used within the scope of the present imention, a particular embodiment of the present invention is shown in detail in FIGS. 2A, 2B, 2C, and 3. With reference to these figures, nozzle 30 has a nipple 32, an upper plate 34, a lower plate 36, and spacer 37. Spacer 37 is omitted from FIG. 2A for clarity. Nipple 32, which is hollow to permit gas flow, is connected to air pipe 312 (as indicated in FIG. 1) and opens into channel 38. Upper plate 34 and lower plate 36 are parallel to each other and are spaced apart by spacer 37 such that channel 38 is formed between them, wherein channel 38 has outlets 40 at each distal end. In other embodiments, multiple channels may be present, wherein each channel may have an outlet at each distal end. By way of example, one embodiment of a nozzle of the present invention has a nipple that connects with three channels, wherein each channel has an outlet at each of its distal ends.

In other embodiments, channel 38 can be formed by two plates being directly attached without a spacer wherein the plates have integral grooves that align to form a channel. In yet further embodiments, the nozzle may be interconnected to a tube or pipe, wherein the hollow interior of the tube or pipe functions as channel 38. It is recognized that one of ordinary skill in the art will readily appreciate other structures suitable to provide for channel 38. In an additional embodiment, the channel is formed by a single plate having a groove, wherein the plate is located against the bottom of a containment unit such that the groove and bottom collectively form a channel. In one particular embodiment of the present invention, the inner diameter of the nipple 32 measures one inch and the length measures nine inches; the upper plate is twenty inches long by four inches wide by 0.25 inches thick; the lower plate is twenty inches long by seven inches wide by 0.25 inches thick; the spacers are twenty inches long by two inches wide by 0.125 inches thick; and channel 38 and outlets 40 have a height (between upper plate 34 and lower plate 36) of 0.25 inches and a width of three inches. In another embodiment, the lower plate is alternatively ten inches wide. In yet another embodiment, the spacers are one inch wide.

In some embodiments, the dimensions of the channels and outlets on a nozzle are designed as a function of the number of outlets on the nozzle. For instance, and by way of example, nozzles having more outlets may have narrower channels and outlets than an otherwise identical nozzle having fewer outlets. Similarly, it will be appreciated that the length of a channel can influence the design dimensions of its channel and outlet. In addition, in some embodiments, outlets on a nozzle may be spaced such that adjacent outlets are no closer than the width of the outlets.

With reference again to FIG. 1, nozzles 30 are individually connected to air pipes 312, although in other embodiments nozzles 30 may be connected to a single air pipe. Nozzle 30 may be connected to air pipe 312 by nipple 32 using any conventional means, such as welding, bonding, hoses, or connection piping. Air pipes 312 are connected to air compressor 318 by way of valve manifold 316 and air pipe 317. Air valves 314, which may be solenoid valves or may have a valve actuator connected thereto, are displaced on air pipes 312 and, as defined below, are in communication with a controller. which is depicted in FIG. 1 as system programmable logic controller (PLC) 334. It will be apparent to one of ordinary skill in the art that other types of controllers may be employed and that a PLC is only one type that may be utilized in the present invention. It will also be apparent to one of ordinary skill in the art that any conventional methods can be used to join these components, such as bonding, welding, connections hoses, and connection pipes. It will also be apparent to one of ordinary skill in the art that additional air piping may be included in other embodiments of the invention. By way of example, an additional pipe for each nozzle 30 may be joined to air pipe 312, and each nozzle 30 may be connected to such an additional pipe and joined indirectly to air pipe 312. As used herein, the term supply line represents any configuration of piping or hosing that connects nozzles to a pressurized air source.

As shown in FIG. 1, system PLC 334 is in communication with computer 336, which may include a user interface, a PC, a PLC, a device to aid the communication between the PC and PLC, and/or other wiring, software, and/or hardware. In some embodiments, membrane programmable logic controller (membrane PLC) 332 (or other membrane controller) may also be in communication with system PLC 334 and/or computer 336. In some embodiments, system PLC 334 may be omitted and membrane PLC 332 may be in communication with computer 336 and utilized for all required functionality of system PLC 334 described herein. In yet other embodiments, system PLC 334 and computer 336 may be combined in a single device. In further embodiments, membrane PLC 332 may be omitted. In other embodiments, more than one system PLC 334 may be present. Based on the foregoing, one of ordinary skill in the art will appreciate that the presence and configurations of these components may vary within the scope of the present invention.

In the embodiment depicted in FIG. 1, dissolved oxygen (DO) probe 320 and total suspended solids (TSS) probe 322 are located in basin 302 and are independently in communication with membrane PLC 332 and system programmable logic controller (system PLC) 334. Transmembrane pressure (TMP) probe 324 is positioned to take readings from within basin 302 and outlet pipe 338. TMP probe 324 is in communication with membrane programmable logic controller (membrane PLC) 332 and system programmable logic controller (system PLC) 334. Permeate flow (PF) probe 328, which may be a flow meter, is located within or in contact with outlet pipe 338 and are in communication with membrane PLC 332 and system programmable logic controller 334. In addition, as described further herein. TSS probe 330 is located at a position upstream and outside of basin 302, and TSS probe 330 is in communication with membrane PLC 332 and system PLC 334. System PLC 334 is in communication with computer 336, which has an undepicted processor and memory. One of ordinary skill in the art will appreciate that both additional and alternative probes and placement locations are within the scope of the present invention.

Furthermore, as shown in the embodiment in FIG. 1, DO probe 320 is in communication with DO probe processor 321, TSS probe 322 is in communication with TSS probe processor 323, TMP probe 324 is in communication with TMP probe processor 325, PF probe 328 is in communication with PF probe processor 329, and TSS probe 330 is in communication with TSS probe processor 331. Probe processors may be supplied with a probe from the probe manufacturer. In some embodiments, membrane PLC 332 may be in communication with system PLC 334 and/or computer 336 in addition to or instead of such communication by probes or probe processors with system PLC 334 and/or computer 336.

As used herein, the reference “in communication with” indicates that data and/or signals are transferrable between the referenced components, and include both physical connections and wireless connections. In addition, “in communication with” also includes embodiments in which the referenced components are in direct connection (i.e., directly connected to each other with a cable) as well as indirect connections, such as when data is transmitted through an intermediate component and either relayed in the same format or converted and then relayed to the referenced component. In other embodiments, some or all of the aforementioned probes may be in communication with a single probe processor.

The depicted system and components thereof are illustrative only, and it will be readily apparent to one of ordinary skill in the art that alternative types of membrane bioreactor systems are within the scope of the present invention. By way of example, alternative air piping, compressor devices, nozzles, and valves, as well as their layout and number, may be employed in alternative embodiments of the present invention.

In some embodiments, system 300 may be used in treating wastewater. In such embodiments, wastewater is fed into basin 302 through inlet pipe 310. Prior to entering basin 302, the wastewater may have been subject to other treatment processes, such as aerobic, anoxic, and/or anaerobic treatment processes. Using processes known to one of ordinary skill in the art, cassettes 308 permit filtration, such as ultrafiltration or microfiltration, along with biological treatment inside basin 302. In particular, using pressure or pumping, influent wastewater is filtered through membranes 307 in a downstream-to-upstream flow direction. After any desired treatment has been performed, the treated wastewater or other substance, or effluent, flows out of basin 302 through one of more outlet pipes 338. In some embodiments, the effluent may be subject to additional treatment processes after exiting basin 302, such as aerobic, anoxic, anaerobic, sediment, and/or other treatments.

During operation, membranes 307 may become polluted due to the fouling by the deposit of soluble and particulate materials onto and into membranes 307. Such fouling may affect membrane permeability and reduce the efficiency of the membranes. In this regard, scouring of membranes 307 to remove any materials may be accomplished by using valves 30 to provide bursts of scouring bubbles to the membranes.

By way of example, the illustrative embodiment of FIG. 1 may operate to scour membranes 307. In the depicted embodiment, a gas supply device, shown in FIG. 1 as air compressor 318, provides pressurized gas into air pipe 317. A conventional regulator may be utilized to control the pressure of the pressurized gas. In some embodiments, the pressurized gas may be a gas or fluid that has a lower density than a wastewater mixture (including any added compounds) that is entering the system from inlet pipe 310, and the term “gas” shall be understood to include both gases and fluids. The pressurized gas flows through air pipe 317, through valve manifold 316, and into air pipes 312. Disposed on air pipes 312 are air valves 314, each of which is capable of opening and closing to selectively and controllably allow the pressurized gas to flow through each air pipe 312. The location of air valves 312 may vary in alternative embodiments of the invention.

When one of valves 314 is opened, the pressurized gas flows through the respective air pipe 312 for that valve and to nozzle 30. In one embodiment, the opening and closing of the valve can be controlled by system PLC 334. In other embodiments, the opening and closing of the valve(s) can be controlled manually. In yet other embodiments, air compressor 318 may be in communication with system PLC 334, and system PLC 334 may operate the flow of air from air compressor 318, such as by controlling the power to air compressor 318.

Furthermore, in some embodiments, some or all of valves 314 may have an exhaust pressure sensor (not depicted) that is in communication with system PLC 334. Such pressure sensors may provide a signal to system PLC 334 each time the valve 14 to which it is attached opens and closes. If the signals do not fall within a predetermined range, a fault in the valve operation may be detected and a signal may be generated to the operator. In this manner, system 300 may include an alert for certain malfunctions, such as when one of valves 314 is stuck open or stuck closed.

When valves 314 are open, the gas flow continues to nozzles 30, and the flow of gas in nozzle 30 is shown by arrows in FIG. 3. As shown, the gas flows into nozzle 30 by entering nipple 32 and then continues to channel 38 and toward outlets 40. In some embodiments, system PLC 334 and computer 336 may be capable of selectively and independently controlling each valve 314. In some embodiments, systems may also be utilized in the context of this invention that use manual manipulation of valves instead of the computerized control system described above.

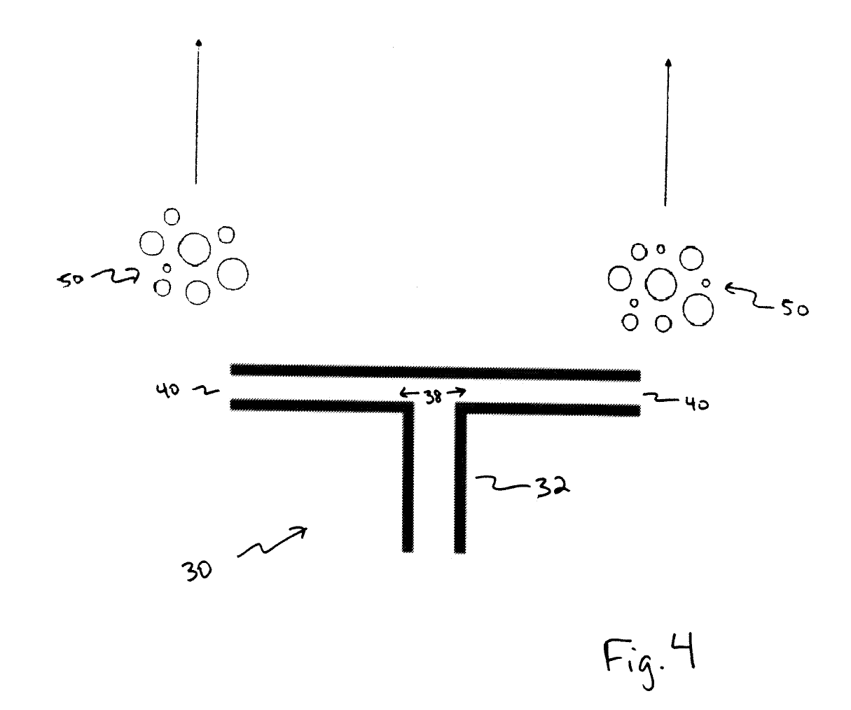

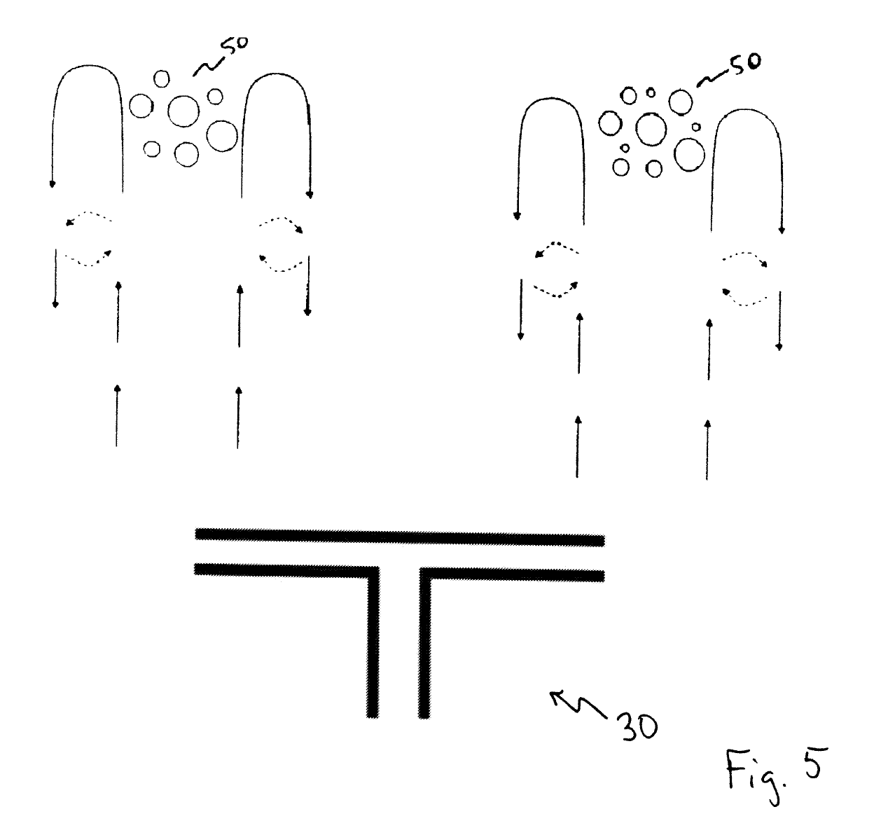

As a result of gas exiting nozzle 30 through outlets 40 and entering cassette 308, nozzle 30 generates a plurality of scouring bubbles 50, which are shown in FIG. 4. In some embodiments of the present invention, scouring bubbles 50 may be larger in size than the bubbles introduced to the system by conventional aerators used in an aeration process for treating wastewater. Some wastewater processes utilize diffusers that generate small bubbles and the diffusers are not operated in a generally cyclical interval. In the present invention, nozzle 30 is used to introduce cyclic, controlled bursts of compressed gas or other fluid as shown in FIG. 5. The bubbles created by the present invention may be generally repeatable to produce the desired scouring.

Scouring bubbles 50 may vary in size, and various parameters may influence the size of the scouring bubbles, such as the size of channel 38 and outlets 40, the flow rate of the pressurized gas, and the density of the pressurized gas. Generally, when similar air pipes and nozzles are used throughout a system, scouring bubbles of generally the same volume and size will be formed by each nozzle in the system when operating under similar conditions. In some embodiments of the present invention, scouring bubbles 50 may be generally larger than bubbles created by conventional aerators used in aeration processes for treating wastewater. In one embodiment of the present nvention, none of scouring bubbles 50 exceed a diameter of six inches. Because in some embodiments the pressurized gas forming scouring bubbles 50 is less dense than the surrounding liquid composition in basin 302, scouring bubbles 50 rise in an upward direction toward cassette 308, as shown in FIG. 6. In this regard, nozzles 30 may be located directly below a cassette in some embodiments of the present invention. The scouring bubbles shown in the figures are representative only and are not to scale. The scouring bubbles of the present invention may vary in quantity and size from the depicted representations and their physical characteristics are dependent on a variety of factors as mentioned above.

As scouring bubbles 50 rise, a displacement of the adjacent fluid within basin 302 may occur. In particular, the rising scouring bubbles 50 may exert a force in an upward direction, thereby creating a vacuum behind the bubbles. This vacuum can be present behind individual bubbles and can also be present from a grouping of scouring bubbles 50 resulting from a gas burst. The vacuum creates a force in the direction of the rising scouring bubbles 50. Ultimately, these scouring bubbles and any forces associated therewith can dislodge and/or displace pollutants on membranes 307, as shown in FIG. 6. As a result of this scouring, the function and efficiency of membranes 307 may be improved as the membranes are cleaned.

In some embodiments of the present invention, the effect of the periodic release of scouring bubbles 50 may include the generation of currents or pathways within cassette 308 and/or basin 302. These currents or pathways may include at least one circular pathway of liquid. As used herein, the term “circular pathway” indicates that near the surface of the liquid level there is a downwardly directed circulation pathway of the fluid.

An example of a possible circular pathway created by the rising scouring bubbles 50 and the trailing vacuum created thereby is depicted by he arrows in FIG. 5. As shown in FIG. 5, scouring bubbles 50 have risen in an upward direction, indicated by the arrows, and a circular pathway shown by the non-dashed arrows is created. In addition, the dashed arrows in FIG. 5 show an additional pathway that can be created by the rising of the scouring bubbles and the vacuums associated therewith. It is understood that these pathways are representative only, and a person of ordinary skill in the art can readily appreciate that additional, alternative, and different pathways can be created by the present invention. However, such currents or pathways may extend beyond the actual burst of scouring bubbles, thereby providing a continued scouring effect.

An example of the scouring function of scouring bubbles 50 is depicted in FIGS. 5 and 6. As shown, scouring bubbles 50 rise from nozzle 30. As indicated above, scouring bubbles 50 contact membranes 307 and create displacement and currents around membranes 307. As a result, membranes 307 are scoured by scouring bubbles 307 and pollutants located thereon or therein may be displaced, which may increase the efficiency and performance of membranes 307.

The periodic bursts of pressurized gas from nozzles 30 as described above can be controlled and varied in terms of both timing and volume to achieve a desired scouring effect. In particular, particular valves 314 can be selectively opened and closed, or opened or closed to certain degrees, to permit a desired amount of pressurized gas to enter into a particular nozzle 30 through each air pipe 312. By controlling the pressurized gas entering each air pipe 312, the resulting burst is also controlled. In a like manner, a desired sequence of bursts from nozzles 30 may be achieved by controlling the sequence of pressurized gas passing through air pipes 312.

The depicted system and components thereof are illustrative only, and it will be readily apparent to one of ordinary skill in the art that additional components, alternative types of components, and alternative arrangements of components are within the scope of the present invention. For instance, in some embodiments, mechanical mixers or other types of nozzles may additionally be used to create displacement and thereby scour membranes. Ultimately, any device that creates sufficient displacement to adequately scour membranes may be suitable for use in the present invention, and such devices are referenced herein as scouring devices. In other embodiments, nozzles or mixers may be displaced within basin 302 or within another basin used for other types of treatment.

In some embodiments of the present invention, it may be useful to control the scouring operation, including the activation, deactivation, frequency, duration, and intensity of scouring, based upon dynamically-measured parameters of the system. By controlling scouring processes based upon dynamically-measured parameters of the system, systems and processes of the present invention may allow for treatment based upon the actual scouring need of the system, as opposed to performing scouring continuously or based upon preset time periods that do not necessarily reflect the actual real-time scouring needs of the membranes. This dynamic monitoring and control may result in avoiding the scouring being activated at unnecessary times and at unnecessary rates, thereby saving mechanical wear and energy costs. In addition, by not continuously providing gas, there may be less risk of increasing the dissolved oxygen concentration in effluent, which may improve subsequent treatment processes, such as denitrification. Moreover, when gas is not continuously provided, the costs of operating the scouring system will likely be reduced.

By way of example, as membranes 307 become polluted, the hydraulic resistance of membranes 307 may be increased. In such instances, the increased hydraulic resistance may result in a decline in membrane flux, an increase in transmembrane pressure, and/or a decrease in permeate flow (or effluent). Therefore, in one embodiment of the present invention, one or more of these parameters may be dynamically monitored and measured in real time to determine if membranes 307 have become polluted.

In order to dynamically monitor parameters of the system for selective scouring, probes for measuring various parameters may be located within system 300. Some probes may directly detect a certain parameter or certain parameters whereas other probes may detect or measure a parameter or parameters that can then be used to compute a desired parameter, either alone or in combination with other data. As used herein, the term “measured” includes, detected parameters, directly-measured values of parameters, and parameter values calculated or otherwise determined from the direct measurement or detection of one or more other parameters, either alone or in combination with additional data or measurements.

As shown in illustrative system 300 in FIG. 1, such probes may include DO probe 320, TSS probe 322. TMP probe 324, permeate flow probe 32, and TSS probe 330. In operation, with reference to FIG. 1, these probes dynamically measure a respective parameter and transmit the measurements to DO probe processor 321, TSS probe processor 323, IMP probe processor 325. PF probe processor 329, and TSS probe processor 331, respectively. In addition, other parameters can be determined from these measured values. By way of example, membrane flux can be calculated using the following equation:

$$Membrane Flux = \frac{Permeate Flow}{Active MembraneArea}$$

In the illustrative embodiment shown in FIG. 1, measured data from the probes is then transmitted from the respective probe processors to membrane PLC 332 and system PLC 334, and system PLC 334 then converts the data and transmits the converted information to computer 336 for processing.

As indicated, other parameter-specific probes may be included in alternative embodiments of the present inventing, either in addition to or in place of the illustrative probes. In addition, in some embodiments, one or more of the illustrative probes may be omitted. In yet other embodiments, multiple probes for measuring a single parameter may be present, such as two or more DO probes 320. In other alternative embodiments, a probe and probe processor may be combined into a single hardware component, and in other embodiments a probe processor may be omitted for some or all probes and probes may be in direct communication with PLC 116 without a probe processor. In some embodiments, the probes may measure the desired parameters without any need for sampling the substance. In this manner, in some embodiments, the probes may be in direct and constant contact with the substance for which parameters are being measured.

Using some or all dynamically-measured parameters, computer 336 and system PLC 334 may control the flow of air to nozzles 30 or may control the on and off of the air compressor 318, thereby controlling the scouring bubble bursts introduced, By way of example, as fouling of the membranes occurs, membrane flux may decline. If the membrane flux value falls below a threshold value, then scouring may be initiated, or gered, as set forth below. Predetermined characteristics for a measured parameter that initiates, terminates, or alters the intensity or duration of scouring may be referenced as a predetermined parameter characteristic. Such predetermined parameter characteristics may include minimum or maximum values of a measured parameter or fluctuation variances of a measured parameter, and such predetermined parameter characteristics may be set for some or all measured parameters. For instance, predetermined parameter characteristics that indicate membrane scouring is required may include a decline in membrane flux, an increase in transmembrane pressure, a decrease in permeate flow (or effluent), an increase in total dissolved solids, and/or an increase in dissolved oxygen, wherein specific values may be determined for the foregoing. In some embodiments, a single predetermine parameter characteristic may be established that includes consideration of multiple parameters.

Similarly, predetermined parameter characteristics of measured parameters may be established for controlling and altering the intensity and duration of scouring. For instance, the intensity and duration of scouring may be determined based upon the membrane flux value, such as increasing the duration and intensity of scouring if membrane flux quickly plummets below a threshold value. In similar fashion, in some embodiments, threshold values may be determined to terminate scouring when the system is returned to optimal membrane functioning.

In some embodiments, more than one parameter may be considered in determining whether to initiate or terminate scouring or in determining or altering the frequency or intensity of scouring. For instance, in one embodiment, scouring may be initiated based upon a consideration of both the measured transmembrane pressure and the measured total suspended solids concentration, wherein these respective values are both considered. In some embodiments, each factor could be assigned a significance value, such as the transmembrane pressure being a more controlling factor than the total suspended solids concentration, but both factors factoring into the ultimate scouring bubble burst control decision.

In addition, in some embodiments, one or more predetermined parameter characteristics may serve as a secondary (or back-up) value for activating, deactivating, or controlling the intensity or frequency of scouring. For instance, if the total dissolved concentration reaches a maximum threshold before a membrane flux reaches a threshold value, then scouring may be activated. In some embodiments, having one or more secondary values for triggering scouring is desirable because it will maintain the proper system functionality in the event that a probe for another parameter is damaged or malfunctioning. Values of any parameters discussed herein may be used as a primary or secondary value, and other parameters may also be used as secondary values.

Upon detection of a threshold value, computer 336 may send a signal to system PLC 334 and, in response, system PLC 334 may signal valves 314 (which may be solenoid valves or may have valve actuator connected therewith) to open and permit gas flow to air pipes 312. As a result. valve 314 is opened and permits air compressor 318 to provide gas to nozzles 30 by way of air pipe 317, valve manifold 316. and air pipe 312. thereby resulting in a bubble burst as described herein. In other embodiments, computer 336 and system PLC 334 may also be in communication with a gas-supply device, such as air compressor 318, and control the flow of gas from the device itself, such as by activating or deactivating the power of the device. In still other embodiments, other types of gas-supply equipment may be started by a different method, such as an electric starter, activated by signals from PLC 334.

In addition to initiating or terminating scouring as explained above, embodiments of the present invention may also be used to regulate scouring based upon dynamic measurements of the parameters. As indicated above, some embodiments of the present invention may control the frequency, duration, and/or intensity of scouring. Therefore, with reference to the exemplary embodiment shown in FIG. 1, a signal from PLC 334 to valves 314 may further specify a degree to which valves 314 should be opened or closed, such as by a regulator, thereby regulating the intensity of the bubble burst generated by controlling the volume and flow rate of gas provided to nozzles 30. Other mechanisms of controlling the intensity of the bubble burst are also within the scope of the present invention. For instance, in some embodiments, PLC 334 may send a signal to an electrically-actuated regulator, thereby adjusting the pressure of gas to the valves. In alternative embodiments of the present invention using other scouring devices, such as mechanical blowers without variable speed drives and that can only be turned on or off, computer 336 and system PLC 334 may signal to deactivate less than all of a plurality of such devices or may control the duration of such devices being activated in order to decrease the overall output of each scouring device.

By way of example, if less fouling appears present based upon dynamically-measured parameters, signals from PLC 334 may restrict the opening of valves 312 such that a smaller volume of gas may be permitted to enter air pipe 312 to reach nozzles 30, thereby producing a smaller bubble burst. By contrast, if significant fouling is detected, such as during a time of increased influent, then larger (i.e., more intense) or more frequent bursts of scouring bubbles may be signaled by PLC 334. In some embodiments, short bursts of gas, resulting in short bursts of bubbles, may be employed. In additional embodiments, such short bursts may be repeated.

As indicated above, the termination of scouring may be based upon some or all of the same measured parameters, some additional parameters, entirely different parameters, combinations of parameters, secondary parameters, and/or entirely different parameters. By way of example, if scouring is commenced, scouring may be terminated when membrane flux is returned to a predetermined value. In some embodiments of the present invention, a predetermined value for terminating scouring may be a different value than the value to initiate scouring. In this regard, some embodiments of the present invention may establish threshold values for terminating scouring such that the membrane function is restored to a level above the threshold for initiating scouring.

In some embodiments, the present invention may also be used to balance the load distribution of total suspended solids (TSS) in the system. In such embodiments, a plurality of TSS probes 322 may be located at various points the membrane tank or basin to measure the TSS concentration at those points. If the dynamically-measured TSS parameters from each probe indicate that the TSS distribution is not uniform in the tank or basin, then scouring bubbles may be released to balance the TSS load in the system. As explained herein, the duration and intensity of the scouring bubbles may be controlled based upon the dynamically-measured TSS parameters.

In some embodiments of the present invention, as indicated above, dynamically-measured parameters may be used to terminate scouring. In similar fashion to activation of scouring, computer 336 may send a signal to system PLC 334 upon detection of a predetermined value or combination of values for terminating scouring. System PLC 334 then transmits a signal to valves 314 and valves 314 are closed. In a similar manner, upon detection of a predetermined value or combination of values of dynamically-measured parameters, adjustments may also be made to the scouring process, such as increasing the intensity or frequency of bursts. In some embodiments of the present invention, one or more measured parameters may be determinative to commence and/or end the formation of scouring bubbles and the measured parameter does not merely trigger the start of the running period of a set treatment time. In this manner, power is conserved and the membranes receive only the scouring necessary, rather than scouring solely according to a preset time period.

In some embodiments of the present invention, the DO level may be used as one exemplary trigger to terminate or limit scouring. For instance, an increased DO level can have an adverse impact on downstream processes in some treatment systems. Therefore, based on a system's requirements, one or more DO values may be established as a threshold that, when reached, will limit or terminate air scouring so that the mixed liquor suspended solids does not become over-aerated.

In addition, in some embodiments, scouring may be jointly controlled for all membranes in a system based upon dynamically-measured parameters, whereas in other embodiments scouring may he selectively controlled for each membrane, or for groups of membranes, based upon dynamically-measured parameters for a particular membrane or membrane group. For instance, parameters may be dynamically measured for each membrane or group of membranes by strategically locating probes within a system to measure parameters relating to a particular membrane or membrane group. By way of example, in the embodiment shown in FIG. 1, TMP probes 324, MF probes 326, and PF probes 328 could alternatively located on each outlet pipe 338 and the measured parameters could be associated with the corresponding cassette 308 such that scouring determinations could be made independently for each cassette. Similarly, DO probes 320 and TSS probes 322 could be located in proximity to particular membranes in some embodiments, and the measured parameters could be associated with those membranes for making individualized scouring determinations. As a result, scouring can be selectively controlled for individual membranes or groups of membranes based upon the measured parameters pertaining thereto.

Time parameters also may be optionally used to control scouring in some embodiments of the present invention. For instance, a maximum period for scouring may be a parameter. In some embodiments, such time parameters could be determined by computer 336 based upon historical operation of the system, historical parameter measurements, and/or system operating conditions, such as flow rate of influent, weather conditions, and/or time of day. As used herein, the term historical scouring data means the previous scouring intensity and duration, the measured parameters at the time of the scouring, and any additional selected data. The time parameters may serve either as a primary trigger for starting and/or stopping the aerobic treatment process, either alone or in combination with other parameters, or alternatively as a secondary (back-up) parameter. In addition, in some embodiments, a flow meter may be connected to air pipe 312 to measure the flow rate of gas, and the flow meter may be in communication with system PLC 334 to provide the measured data to computer 336 for processing and storage.

The requirements and operational preferences for a particular system may vary based upon the facility or at various times for a particular facility. In some embodiments of the present invention, system requirements and preferences, such as threshold values and operational parameters, may be loaded into computer 336. In other embodiments, computer 336 or system PLC 334 may be in communication with another controller, such as programmable logic controller, or computer, either at the treatment facility or at another site, at which the operational parameters can be set and transmitted to computer 336. For instance, an existing facility may have existing PLCs or computers or hardware and, in some embodiments, the present invention may be interfaced with those existing systems, such as by loading software to perform the processes described herein and communicate with the previously-existing structures. In other embodiments, computer 336 may be configured to a network or internet connection and may be remotely accessible, such as through an internet interface. Computer 336 may also permit an operator to manually control the processes and system components, such as by manually overriding the automatic control and manually controlling scouring. In this regard, computer 336 may include an interface for inputting such manual instruction.

In some systems, influent wastewater may continually flow into the system for treatment, and the amount, flow rate, suspended solids level, and concentration of the wastewater can vary based upon many factors. For instance, certain peak times such as morning and early evening may produce increased wastewater influence, whereas weather conditions such as rain may dilute influent wastewater and require less scouring. The quantity and content of such influent wastewater may affect the fouling of membranes. For instance, a high volume of influent wastewater or influent wastewater having a high quantity of suspended solids may result in membranes becoming more rapidly polluted.

In some embodiments, influent wastewater may be monitored to anticipate and predict necessary scouring. For instance, as shown in the embodiment depicted in FIG. 1, TSS probe 330 may be located upstream from basin 302, such that the solids in influent wastewater can be considered in advance. Based upon such information, computer 336 can predict necessary scouring and make any necessary preparations for such scouring.

In addition, some embodiments of the present invention, and particularly computer 336, may store historical data of the measured parameters and scouring cycles. In addition, other values may be stored, such as temperature, time of day, rain volume, and influent flow rate and volume. This historical information may then be used to perform predictive analysis for scouring and scouring cycles in order to schedule or anticipate scouring in a given system. In addition, this data may be measured or may be loaded into the system from other sources. For instance, temperature and rain volume could be obtained and loaded, either automatically or manually, from a weather service.

By way of example, in some embodiments, computer 336 may store historical data, such as the valve position regulating gas flow that was used in previous treatment processes that effectively reduced fouling. Then, in subsequent treatment processes, the previously-used valve position may be applied to reduce fouling under similar conditions. At the same time, in some embodiments, dynamic monitoring and adjustment may continue so that the valve position is adjusted if the fouling is not adequately reduced by the setting employed based upon predictive analysis. Other historical data could be considered in alternative embodiments, such as the factors discussed above.

Other wastewater treatment processes and applications unrelated to wastewater treatment are also within the scope the present invention. By way of example, in some embodiments, scouring could be used to clean hardware components other than membranes. Similarly, embodiments of the present invention could include scouring in sludge treatment, other wastewater treatment processes, water storage, chemical storage, sequencing batch reactors, and pumping stations.

The foregoing description of illustrative embodiments of the invention has been presented only for the purpose of illustration and description and is not intended to be exhaustive or to limit the invention to the precise forms disclosed. Numerous modifications and adaptations thereof will be apparent to those of ordinary skill in the art without departing from the scope of the present invention.

It will be understood that each of the elements described above, or two or more together, may also find utility in applications differing from the types described. While the invention has been illustrated and described in the general context wastewater treatment, it is not intended to be limited to the details shown, since various modifications and substitutions can be made without departing in any way from the spirit and scope of the present invention. As such, further modifications and equivalents of the invention herein disclosed may occur to persons skilled in the art using no more than routine experimentation, and all such modifications and equivalents are believed to be within the spirit and scope of the invention as described herein.

We claim:

1. A scouring system for use in scouring membranes in a membrane bioreactor comprising,
a source of pressurized gas connected to a supply line;
a nozzle connected to the supply line, wherein the nozzle comprises a nipple connected to at least one partially enclosed channel comprising at least two outlets, the at least two outlets being located at opposite distal ends of the channel, each of the outlets defining a passage through which short bursts of pressurized gas from the source of pressurized gas may be released simultaneously to form a burst of a plurality of bubbles from each outlet; and
a valve located between the source of compressed air and the nozzle;
wherein the nozzle is located in proximity to a membrane of a membrane bioreactor such that a burst of bubbles released from the nozzle scours the membrane.

2. The system of claim 1 wherein the majority of the bubbles released from the nozzle have a greater diameter than conventional diffusion bubbles used in aeration processes.

3. A system for automatically controlling a maintenance scouring process for membranes in a membrane bioreactor based upon at least one dynamically-measured parameter, the system comprising:
a probe for dynamically asuring at least one parameter within the system,
a computer in communication with the probe, wherein the computer receives data from the probe representing the measurement of the at least one dynamically-measured parameter.
a controller in communication with the computer, and
a scouring device in communication with the controller,
wherein the system activates the scouring device based upon measurement of a first parameter characteristic of the dynamically-measured parameter and the system deactivates the scouring device based upon measurement of a second parameter characteristic of a dynamically-measured parameter, and
wherein the scouring device is located in proximity to a membrane of a membrane bioreactor such that a burst of bubbles released from the scouring device scours the membrane.

4. The system of claim 3 wherein the first parameter characteristic and the second parameter characteristic are characteristics of the same dynamically-measured parameter.

5. The system of claim 3 wherein the at least one dynamically-measured parameter is selected from the group consisting of membrane flux, transmembrane pressure, permeate flow, total dissolved solids, and dissolved oxygen.

6. The system of claim 5 wherein the scouring device is a nozzle comprising a nipple connected to at least one partially enclosed channel comprising at least two outlets, each of which is located at distal ends of the channel and each of which defines a passage, wherein the nozzle is connected to a source of pressurized gas by way of a nipple and a supply line, and a valve in communication with the controller and located between the source of compressed air and the nozzle, and wherein the valve may be opened and closed by signals from the controller for providing short simultaneous bursts of pressurized gas through each passage from the source of pressurized gas to form a burst of a plurality of bubbles from each outlet.

7. The system of claim 6 wherein the system controls the intensity of scouring based upon the at least one dynamically-measured parameter, wherein the intensity of scouring is controlled by a regulator opening or closing the valve to a degree to permit gas flow to the nozzle of a desired quantity and at a desired flow rate.

8. The system of claim 6 wherein the system's historical scouring data are stored by the computer.

9. The system of claim 8 wherein the computer performs predictive analysis based upon some or all of the stored system's historical scouring data.

10. A method for controlling the scouring of a membrane in a membrane bioreactor based upon dynamically-measured data, the method comprising the steps of:
measuring at least one parameter of the membrane bioreactor system,
activating scouring of the membrane based upon measurement of a first characteristic of the measured parameter, and
deactivating scouring of the membrane based upon measurement of a second characteristic of a measured parameter,
wherein the scouring is accomplished by emitting from a scouring device a burst of a plurality of bubbles in proximity to the membrane such that the burst of bubbles released from the scouring device scours the membrane.

11. The method of claim 10 wherein the at least one measured parameter is selected from the group consisting of membrane flux, transmembrane pressure, permeate flow, total dissolved solids, and dissolved oxygen.

12. The method of claim 10 wherein at least two bursts of a plurality of bubbles are formed by providing a regulated amount of pressurized gas to a scouring device comprising a channel having at least two outlets located at distal ends of the channel by simultaneously providing the pressurized gas to each of the at least two outlets and wherein the gas is emitted from the outlets to form the at least two bursts of a plurality of bubbles.

13. The method of claim 10 wherein scouring is activated based upon measurement of both a characteristic of the at least one measured parameter and a characteristic of a second measured parameter.

14. The method of claim 10 wherein scouring is deactivated based upon measurement of both a characteristic of the measured parameter and a characteristic of a second measured parameter.

15. The method of claim 13 wherein scouring is deactivated based upon measurement of both a characteristic of the measured parameter and a characteristic of a second measured parameter.

16. The method of claim 10 wherein the intensity of scouring is determined based upon the at least one measured parameter of the system, and wherein the intensity of scouring is controlled by limiting the quantity and flow rate of gas provided to the nozzle.

17. The method of claim 10 further comprising storing historical scouring data.

18. The method of claim 17 further comprising performing predictive analysis for scouring based on the stored historical scouring data.
